(19) United States
(12) Patent Application Publication
(10) Pub. No.: US 2005/0199188 A1
(43) Pub. Date: Sep. 15, 2005

(54) System for rearing fish

(76) Inventor: Colin John Macleod, Carlton-On-Trent (GB)

Correspondence Address: CLARK & BRODY, 1090 VERMONT AVENUE, NW, SUITE 250, WASHINGTON, DC, 20005, US

(21) Appl. No.: 10/522,844

(22) PCT Filed: Jul. 31, 2003
(86) PCT No.: PCT/GB03/03373

§ 371 Date: Jan. 28, 2005

(30) Foreign Application Priority Data
Aug. 2, 2002 (GB) 0218024.8

(51) Int. Cl. A01K 61/00; A01K 63/04

(52) U.S. Cl. 119/223; 119/226

(57) ABSTRACT

An onshore fish farming system comprises a holding tank, means for intake of sea-water to the holding tank and means for discharge of water from the holding tank to generate a flow of water through the tank, in which the discharge means comprises means for collection of waste material from the bottom of the tank and removing said waste material entrained in the discharge water. The holding tank is disposed with its major or longitudinal axis essentially parallel with the local shoreline, the intake water being abstracted relatively upstream and the discharge water being returned relatively downstream with respect to the or any ambient current along the shore.

This invention relates to a system for rearing fish, in particular to the farming of sea fish such as salmon and cod.

The present system for farming sea fish is based on a “suspended cage” type system in which a reticulated, typically netting, enclosure is suspended from floats located offshore, whereby the fish to be farmed are contained but are subject to ambient sea-water properties and conditions. However, the system is normally operated in deep water and requires an extensive network of jetties or pontoons as well as boats to access the system, with attendant risks to operators especially in bad weather. There is also a build-up of waste products and food on the sea bed beneath the cage which in turn results in contamination of the marine environment, exacerbated by chemicals required to treat, for example by delousing, the growing fish. Quite often, stock fish escape through torn netting and wild fish and predators gain entry into the cage zone where the fish are being reared. This can lead to crossbreeding and transference of diseases as well as further losses of stock.

The traditional fish farming systems, including the anchor cables for the floats, are a danger to shipping, and efficient operation of the systems can be compromised by the weather. Both capital and operational costs of suspended cage type systems can be very high. For example, the cages require frequent maintenance because the nets become blocked with jelly fish and seaweed. When weather conditions prohibit operators from clearing the nets, a build-up of fish waste and ammonia results, thereby contaminating the cage itself and the surrounding area and producing methane gas below the cage. Contamination of the local marine environment from the various sources is believed to be instrumental in causing a decline in the population of other fish and marine species.

An object of the invention is to provide a marine fish farming system which avoids the problems of conventional systems.

In one aspect, the present invention provides an onshore fish farming system comprising a holding tank, means for intake of sea-water to the holding tank and means for discharge of water from the holding tank to generate a flow of water through the tank, in which the discharge means comprises means for collection of waste material from the bottom of the tank and removing said waste material entrained in the discharge water.

Preferably, the main or holding tank is formed with at least one sloping wall to define a generally V-shaped cross section, whereby waste material accumulates under gravity at the bottom of the tank in a concentration locally higher than elsewhere in the tank, and the discharge means has a collection or incident conduit including apertures to allow waste material access to the conduit with the water drawn into the conduit for passage through the discharge means. The flowrate through the conduit is preferably enhanced by a pump means which may, for example, comprise a syphon pump or, alternatively or additionally, an electrically-powered pump. Passage of waste material-loaded water through the conduit may be facilitated by mechanical means such as a screw conveyor or a ribbed or otherwise-segmented flat belt conveyor. The tank may have a bottom comprising valleys or troughs separated and defined by one or more internal ridges as, for example, in a W-shaped cross section, with discrete discharge means at the lower region of each valley or trough.

The intake means comprises a pump which preferably includes an upstream strainer means to remove any wild fish, molluscs, crustaceans, seaweed and other macro extraneous material entrained in the intake water.

The pump is preferably submersibly-mounted but may be located on-shore, for example in a pump house, and the intake should preferably be located at least one metre below the lowest level of the sea at low water. The intake water is preferably passed from a rising main through a header tank provided with filter means to remove smaller-scale extraneous material, such as particles of sand, mussel spat and the like, and sterilisation means to kill any living matter such as microorganisms before being passed to the holding tank. The filter means may comprise a simple strainer element for light-duty requirements or for example a mechanical drum-type filter for heavier-duty requirements. A standby pump is preferably provided to augment the flowrate as required by operational criteria or to be used in the event of a fault in the main pump. The standby pump is preferably connected to the same rising main to the header tank. The standby pump may also be used to increase overall water flow on a short term basis to enhance the rate of removal of waste material from the holding tank through the discharge means. Intake water from the header tank to the holding tank is preferably passed through one or more air-entraining venturi, in order to increase the level of oxygen in the water. Additionally or alternatively, oxygenation of intake water may be provided by direct diffusion of gaseous oxygen into the holding tank or into the header tank or by employing a separate pumping system to entrain air into the intake water. A small submerged pump may be provided below the intake water pipe, or the pipe may have an extension to the lower part of the tank, to increase local turbulence as a measure to prevent flow stagnation. Oxygen enrichment may be controlled manually or automatically with the use of oxygen-sensors and feedback control. Intake water to the holding tank is preferably introduced below water level, to reduce surface disturbance and resulting loss of oxygen.

In order to ensure that fish stocks are maintained in optimum condition, the salinity of the water in the holding tank may be adjusted by addition of fresh water to the tank, preferably via the rising main upstream of the sterilisation means and the filter means. The ability to mix fresh and salt water reduces the incidence or effect of parasitic lice. Saline control may be effected manually or automatically. Optionally, the water in the holding tank is recirculated through an external biological filter to remove ammonia and other toxic contaminants and effect re-oxygenation of the water.

The discharge means preferably comprises separation means for removal of solid waste material, whereby water returned to the sea is relatively unpolluted. The separation means may comprise a weir separator or a drum filter, by way of example. Conveniently, the separation means includes two or more independently-operable parts or chambers with means selectively to deliver waste water from the holding tank thereto, whereby one chamber or part remains in service while the other is being cleaned. The waste products recovered may be dried and used as fertiliser after appropriate treatment, for example to remove bacteria.

In the fish farming system according to the invention, the holding tank is preferably disposed with its major or longitudinal axis essentially parallel with the local shoreline, the intake water being abstracted relatively upstream and the discharge water being returned relatively downstream with respect to the or any ambient current along the shore.

The holding tank may be excavated behind the high-water mark of the shore or may at least partially be formed from prefabricated components such as ribbed panels; the tank is preferably lined with a flexible, tear-resistant liner. An excavated lagoon-type tank is preferably stabilised with a sprayed-on coating, for example of a fibrous cement mix, before application of the liner. The tank may be landscaped to minimise visual impact. For servicing purposes, a peripheral walkway may be provided and, optionally, hoppers for holding fish food, automated feeder discharge units and the lice may be disposed at convenient locations around the periphery of the tank.

An electrical control panel connected to the pumps, any lighting installations, sensors for oxygen, ammonia and other chemicals and any other electrical components may be provided at a convenient location. Underwater lighting may be provided to address the reduction of grilse conversion and underwater cameras or other recording equipment may be used for monitoring purposes. Outputs from the sensors and monitors may be passed to and processed by a data logger and personal computer for control or recordal purposes.

Embodiments of the invention will now be described by way of example with reference to the accompanying drawings, of which:

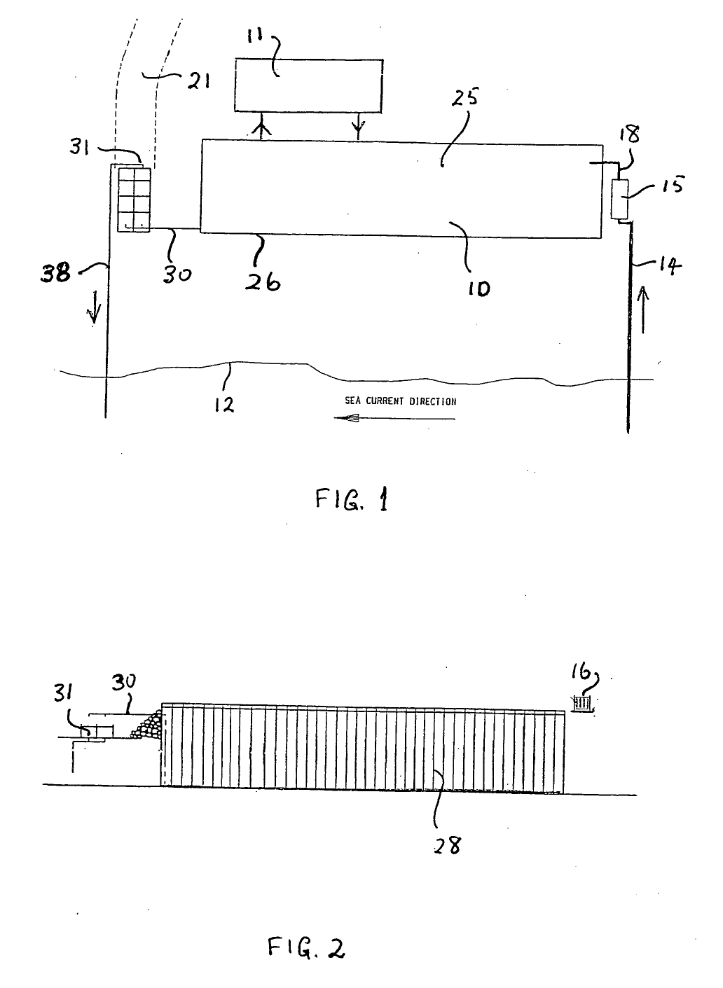

FIG. 1 is a schematic plan view of a fish farming installation according to the invention;

FIG. 2 is a frontal elevation of the system of FIG. 1;

FIG. 3 is a sectional view of the installation from the waste tank end, showing a V-shaped holding tank;

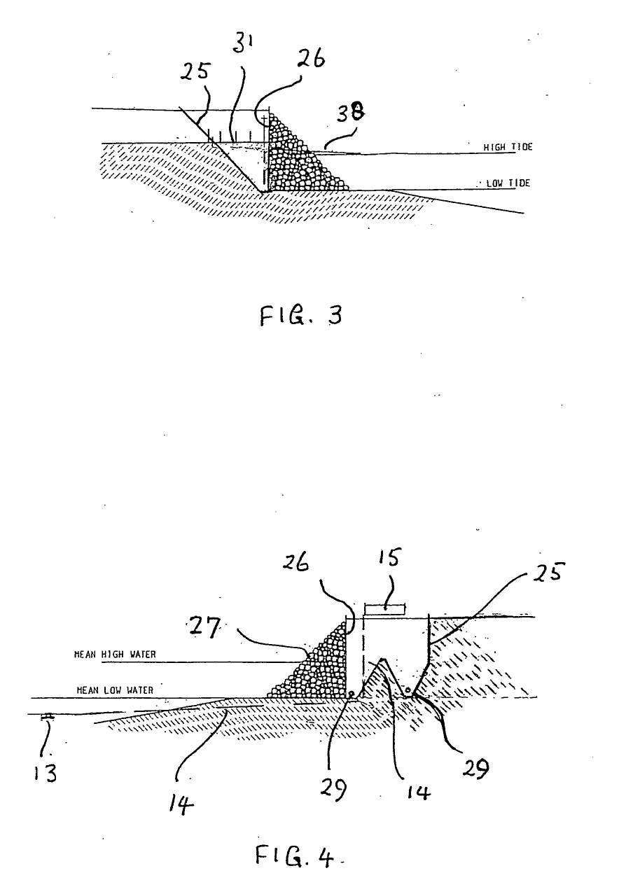

FIG. 4 is a sectional view from the intake end, showing a W-shaped holding tank; and

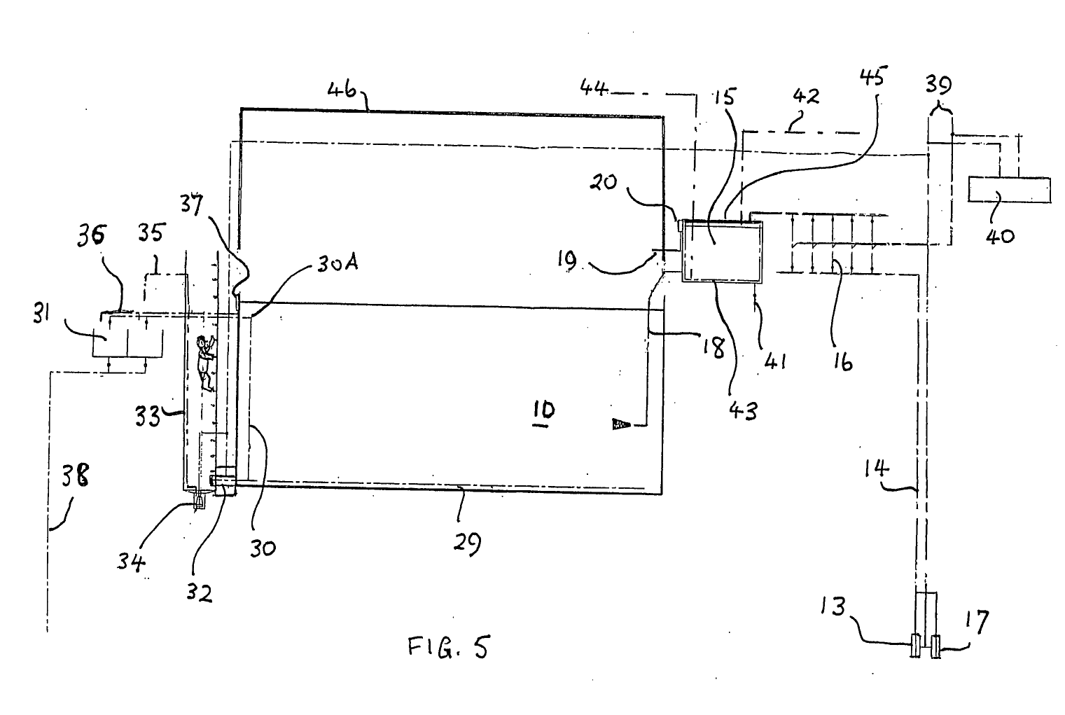

FIG. 5 is a schematic front elevation view showing the water supply and power supply circuits of the installation.

Referring firstly to FIG. 1, the holding tank 10 is shown disposed parallel with the shore line 12, the current direction flowing from right to left as shown and with intake water taken from relatively upstream and discharge water being returned relatively downstream, through pipeline 38. Intake water from the sea is pumped by a submersible pump 13 (see FIG. 4) through a rising main 14 to a header tank 15 with filtration provision and fresh water intake for mixing and make-up purposes. Ultra-violet steriliser units 16 (see FIGS. 2 and 5) are mounted adjacent the header tank, either in a vertical or horizontal array, in order to kill unwanted microorganisms in the intake water. An auxiliary or standby pump 17 (FIG. 5) also feeds into the rising main. The header tank 15 has an outlet pipe 18 to the holding tank with its outlet below the water surface, an overflow pipe 19 which also feeds to the holding tank and a skimmer trap and level limit 20.

The holding tank 10 is formed in a partially excavated depression formed in the shore, whereby the rear wall 25 is constituted by the excavated banking and the vertical front wall 26, landscaped and ballasted by rocks and fines 27, is formed by prefabricated rib elements 28, sealed and bolted together along edge flanges, the walls of the tank being lined with a flexible liner material. Although not shown in the drawings, a peripheral walkway and handrail are provided around the edge or lip of the holding tank for servicing and fish-feeding purposes. An access road 21 is provided to the installation. A recirculation tank 11 is disposed behind the holding tank 10 and contains a biological filter for removal of ammonia and a re-oxygenation supply for the water returned to the holding tank.

A perforated, for example slotted, waste collection pipe 29 is disposed longitudinally of the holding tank towards the bottom thereof and, at the discharge end of the tank, is formed with a rising portion 30 which feeds waste water into settlement tanks 31 by means of a syphon effect. A syphon break hole 30A is provided at the upper elbow of the discharge pipe. The horizontal part of the pipe 29 contains a screw or auger mechanism rotatably connected to a drive motor and gearbox 32. The motor 32 may be serviced via an inspection chamber 33 which contains, at the bottom thereof, a float-switched submersible pump 34 to enable the inspection chamber to be emptied of water for servicing purposes through pipe 35. The settling tanks 31, arranged in a double row for alternately cleaning and use, are also fed through an overflow pipe 36 from the holding tank via skimmer trap and level limit 37 and discharge through a common outlet pipe 38 for returning used water to the sea.

As shown in the drawings, the holding tank is arranged to be substantially between mean low and high water marks for minimal environmental impact. In FIG. 3, the holding tank has a V-shaped cross section whereas in FIG. 4 the bottom has parallel valleys each containing a respective waste collection pipe 29 and is in the form of a W-shaped cross section.

With particular reference to FIG. 5, it is seen how incoming water, having been suitably sterilised and strained, is passed through the holding tank 10 (and recirculated through the biological filter tank 11) on an open loop basis to create therein a simulated current, the outlet water being drawn through the perforated pipe 29 with solid waste matter entrained therein for return to the sea via the waste collection and settlement tanks 31. Electricity feed supplies 39 are connected to the ultra-violet sterilisers 16, to the main and auxiliary feed pumps 13, 17 and to the inspection chamber pump 34. An auto-switched standby generator 40 is connected to the electricity feed supplies 39. The header tank 15 has a drain-down valve and pipe 41, a fresh water feed 42 for make-up purposes, and incorporates an oxygen sparge system 43 fed through line 44 from a liquid oxygen storage tank. A sealed, removable lid 45 is provided to the header tank and a removable cover 46 to the holding tank to exclude debris.

Oxygen sensors are located in the header-strainer tank 15, the holding tank 10 and in the outflow pipe 30. Ammonia sensors are provided in the holding tank, as are salinity sensors, carbon dioxide sensors and temperature sensors. The header/strainer tank is also equipped with a temperature sensor. The outputs from the sensors are fed to a control and display unit for adjustment of input parameters as required.

Typical dimensions for a 100 tonne production unit are an along-shore overall length of 70 m, and a maximum depth of 10 m.

Using the system according to the invention, fish may be efficiently farmed without creating any dangers to passing shipping and without problems for operatives associated with adverse weather conditions. The system requires reduced operational maintenance time and is therefore more economically efficient than conventional systems and, additionally, allows effective control over the quality both of the inlet and discharge water with less environmental harm being created and a lower incidence of disease in the farmed fish.

1. An onshore fish farming system, the system comprising a holding tank, means for intake of sea-water to the holding tank and means for discharge of water from the holding tank to generate a flow of water through the tank, in which the discharge means comprises means for collection of waste material from the bottom of the tank and removing said waste material entrained in the discharge water.

2. A system according to claim 1, in which the tank is formed with at least one sloping wall to define a generally V- or W-shaped cross section.

3. A system according to claim 1, in which the discharge means has a collection or incident conduit including apertures to allow waste material access to the conduit with the water drawn into the conduit for passage through the discharge means.

4. A system according to claim 3, in which the conduit is operatively connected to a pump means.

5. A system according to claim 1, in which the waste material collection and removal means comprises a conveyor means.

6. A system according to claim 1, including means to adjust the salinity of the water in the holding tank by addition of fresh water to the tank.

7. A system according to claim 1, in which the discharge means comprises separation means for removal of solid waste material.

8. A system according to claim 1 when installed with the holding tank disposed with its major or longitudinal axis essentially parallel with the local shoreline, intake water being abstracted relatively upstream and the discharge water being returned relatively downstream with respect to the or any ambient current along the shore.

9. A system according to claim 8, in which the holding tank is excavated behind the high-water mark of the shore or at least is partially formed from prefabricated components.

10. A system according to claim 1 including sensors for some or all of oxygen, ammonia, saline concentration, carbon dioxide and temperature, connected to a control unit for adjustment of input parameters.

11. A system according to claim 1, further including a biological filter disposed externally of the holding tank and connected thereto by partial water re-circulation means.

12. A system according to claim 2, in which the discharge means has a collection or incident conduit including apertures to allow waste material access to the conduit with the water drawn into the conduit for passage through the discharge means.
